(19) United States
(12) Patent Application Publication
(10) Pub. No.: US 2012/0032936 A1
(43) Pub. Date: Feb. 9, 2012

(54) PLASMA DISPLAY AND DRIVING APPARATUS THEREOF

(75) Inventors: Suk-Ki Kim, Yongin-si (KR); Sang-Chul Han, Yongin-si (KR); Sang-Hun Park, Yongin-si (KR)

(73) Assignee: Samsung SDI Co., Ltd., Yongin-si (KR)

(21) Appl. No.: 12/979,562

(22) Filed: Dec. 28, 2010

(30) Foreign Application Priority Data
Aug. 9, 2010 (KR) 10-2010-0076621

(51) Int. Cl. G09G 5/00; G09G 3/28

(52) U.S. Cl. 345/211; 345/60

(57) ABSTRACT

A plasma display is disclosed. In the plasma display, a first transistor for applying a low level voltage of a sustain pulse is connected to a high voltage terminal of a scanning circuit and a second transistor for applying a high level voltage of the sustain pulse is connected to a low voltage terminal of the scanning circuit. The first and the second transistors are alternatively turned on during sustain period, and the sustain pulse is applied to the scan electrode.

### CROSS-REFERENCE TO RELATED APPLICATIONS

This application claims priority to and the benefit of Korean Patent Application No. 10-2010-0076621 filed in the Korean Intellectual Property Office on Aug. 9, 2010, the entire contents of which are incorporated herein by reference.

### BACKGROUND

1. Field

The disclosed technology relates to a plasma display and driving apparatus thereof.

2. Description of the Related Technology

A plasma display uses a plasma display panel to display characters or images with plasma generated by a gas discharge. A plurality of cells are arranged on the plasma display panel.

Generally, the plasma display is driven by dividing one frame into a plurality of subfields, and a gray scale is displayed by the combination of the subfields. A scanning pulse having a negative voltage is applied to a plurality of scan electrodes in order to select emission cells and non-emission cells during an address period of each subfield. Sustain pulses that of alternating high level voltages (for example, Vs voltage) and low level voltages (for example, 0V) are applied to a scan electrode and a sustain electrode in order to perform a sustain discharge during the sustain period.

For the operation, a driving circuit for driving the scan electrode includes a transistor for sequentially applying a scanning pulse to the plurality of the scan electrodes, a transistor for applying the low level voltage of the sustain pulse, and a transistor for applying the high level voltage of the sustain pulse. In addition, the driving circuit for driving the scan electrode includes a path blocking transistor for blocking the path formed by the body diode of the transistor for applying the low level voltage of the sustain pulse when the transistor for applying the scanning pulse is turned on. Therefore, the driving circuit for driving the scan electrode applies the sustain pulse to the scan electrode during sustain period through the path blocking transistor. When the sustain pulse is applied to the scan electrode through the path blocking transistor, distortion of the sustain pulse is generated due to voltage drop in the path blocking transistor. As a result, sustain discharge is not stably performed during the sustain period.

In addition, the path blocking transistor should use a high-voltage-resistant switch, since a negative scanning pulse is applied to the scan electrode during address period. However, there is a problem that the high-voltage-resistant switch is expensive.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One inventive aspect is a plasma display, including a scan electrode, and a scanning circuit including a high voltage terminal and a low voltage terminal, and configured to drive the scan electrode with a scan signal having a voltage of the high voltage terminal or a voltage of the low voltage terminal. The display also includes a first sustain driver configured to apply a first sustain signal alternately having a first voltage and a second voltage to the scan electrode during a sustain period, where the second voltage is greater than the first voltage, a first capacitor connected between the low voltage terminal and the high voltage terminal, and configured to store a third voltage, and a first transistor connected between the first capacitor and the high voltage terminal and turned on during an address period, where the scanning circuit includes a second transistor including a first terminal connected to the high voltage terminal and a second terminal connected to a first power supply configured to supply the first voltage, and a third transistor connected between the low voltage terminal and a second power supply configured to supply the second voltage.

Another inventive aspect is a driving apparatus of a plasma display, the display including a scan electrode and a sustain electrode for performing a display operation. The display includes a scanning circuit including a high voltage terminal and a low voltage terminal, and is configured to drive the scan electrode with a scan signal having a voltage of the high voltage terminal or a voltage of the low voltage terminal. The display also includes a first capacitor connected between the low voltage terminal and the high voltage terminal, and configured to store a third voltage, a first transistor including a first terminal connected to the high voltage terminal and a second terminal connected to a first power supply configured to supply the first voltage, a second transistor connected between the low voltage terminal and a second power supply configured to supply the second voltage, and a third transistor connected between the first capacitor and the high voltage terminal and is turned on during a sustain period, where the first and the second transistors are alternatively turned on during the sustain period.

### BRIEF DESCRIPTION OF THE DRAWINGS

FIG. 1 is a drawing showing a plasma display according to an exemplary embodiment;

FIG. 2 is a drawing showing a driving waveform of a plasma display according to an exemplary embodiment;

FIG. 3 is a drawing showing a driving circuit according to a first exemplary embodiment;

FIG. 4 is a signal timing drawing showing a driving circuit according to the first exemplary embodiment;

FIG. 5A to FIG. 5E are drawings showing current paths according to the signal timing as shown in FIG. 4;

FIG. 6 is a drawing showing a driving circuit according to a second exemplary embodiment;

FIG. 7 is a signal timing drawing showing a driving circuit according to the second exemplary embodiment; and

FIG. 8A and FIG. 8B are drawings showing current paths according to the signal timing as shown in FIG. 7.

### DETAILED DESCRIPTION OF CERTAIN INVENTIVE EMBODIMENTS

Various aspects and embodiments will be described more fully hereinafter with reference to the accompanying drawings, in which exemplary embodiments are shown. As those skilled in the art would realize, the described embodiments may be modified in various ways, without departing from the spirit or scope of the present invention.

The drawings and description are to be regarded as illustrative in nature and not restrictive. Like reference numerals generally designate like elements throughout the specification. In the specification and the claims that follow, when it is described that an element is “coupled” to another element, the element may be “directly coupled” to the other element or “electrically coupled” to the other element through a third element.

Hereinafter, a plasma display according to an exemplary embodiment and a driving apparatus thereof will be described in detail.

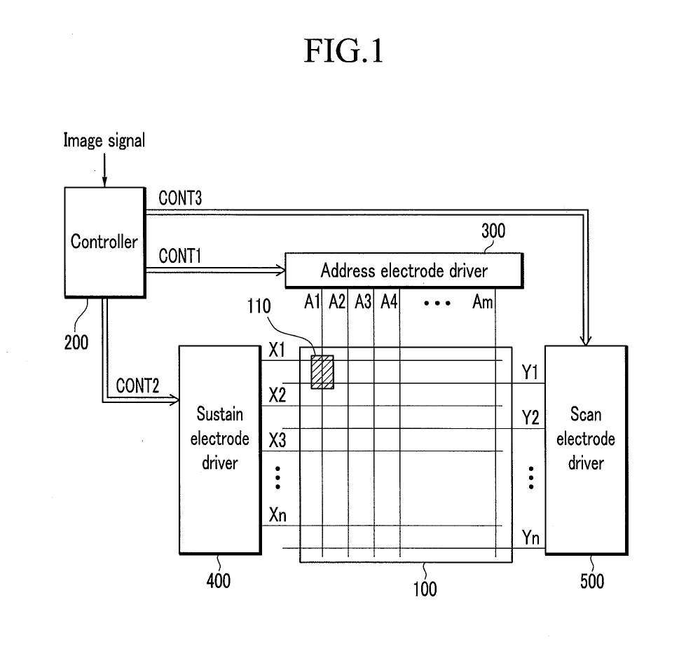

FIG. 1 is a diagram showing a plasma display according to an exemplary embodiment.

Referring to FIG. 1, a plasma display panel 100, a controller 200, an address electrode driver 300, a sustain electrode driver 400, and a scan electrode driver 500.

The plasma display panel 100 includes a plurality of address electrodes (hereinafter, referred to as “A electrode”) Al to Am extending in a column direction and a plurality of sustain electrodes (hereinafter, referred to as “X electrode”) X1 to Xn and a plurality of scan electrodes (hereinafter, referred to as “Y electrode”) Y1 to Yn extending in a row direction while being formed in a pair each other. Generally, the X electrodes X1 to Xn are formed corresponding to the Y electrodes Y1 to Yn, wherein the X electrodes X1 to Xn and the Y electrodes Y1 to Yn display images for the sustain period. The Y electrodes Y1 to Yn and the X electrodes X1 to Xn are disposed to be orthogonal to the A electrodes A1 to Am. In this configuration, the discharge space disposed at the intersection portions between the A electrodes A1 to Am and the X and Y electrodes X1-Xn and Y1-Yn forms a discharge cell (hereinafter, referred to as ‘cell’) 110. This shows, by way of example, an structure of the plasma display panel 100 and therefore, a panel having anther structure applied with the driving waveform to be described below may be applied.

The controller 200 divides one frame into a plurality of subfields having each weight value and drives the subfields. Each subfield includes an address period and a sustain period. The controller 200 receives image signals from the outside for one frame, to generate an A electrode driving control signal CONT1, an X electrode driving control signal CONT2, and a Y electrode driving control signal CONT3, and outputs them to address, sustain and scan electrode drivers 300, 400, and 500, respectively.

The address electrode driver 300 applies driving voltage to the A electrodes A1 to Am according to the A electrode driving control signal CONT1 from the controller 200.

The sustain electrode driver 400 applies the driving voltage to the X electrodes X1 to Xn according to the X electrode driving control signal CONT2 from the controller 200.

The scan electrode driver 500 applies the driving voltage to the Y electrodes Y1 to Yn according to the Y electrode control signal CONT3 from the controller 200.

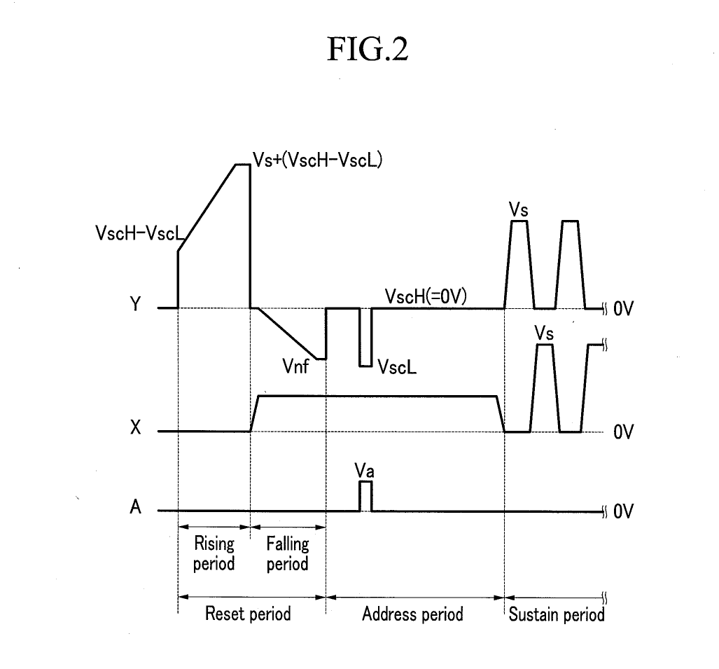

FIG. 2 is a diagram showing a driving waveform of the plasma display according to an exemplary embodiment. For convenience, FIG. 2 shows only one of the plurality of subfields and only the driving waveforms applied to the Y electrode, the X electrode, and the A electrode forming one cell will be described.

Referring to FIG. 2, the address electrode driver 300 and the sustain electrode driver 400 each biases the A electrode and the X electrode to a reference voltage (0V voltage in FIG. 2) for a rising period of the reset period and the scan electrode driver 500 increases the voltage of the Y electrode from 0V to VscH−VscL voltage and then, gradually increases from VscH−VscL voltage to Vset voltage. In this case, the Vset voltage may be Vs+(VscH−VscL) voltage. FIG. 2 shows that the VscH voltage is 0V. FIG. 2 shows a case in which the voltage of the Y electrode is increased in a ramp type. Then, a weak discharge (hereinafter, referred to as “weak discharge”) is generated between the Y electrode and the X electrode and between the Y electrode and the A electrode while the voltage of the Y electrode is increased and at the same time, (−) wall charge is formed in the Y electrode and (+) wall charge is formed in the X and A electrodes. In this case, the Vset voltage may be set to be larger than the discharge initial voltage between the X electrode and the Y electrode so that the discharge is generated in all the cells.

The sustain electrode driver 400 biases the X electrode to Ve voltage and the scan electrode driver 500 lowers the voltage of the Y electrode from Vset voltage to 0V voltage and then, gradually reduces from 0V voltage to Vnf voltage, for the falling of the reset period. In this case, the Vnf voltage may be the same as VscL voltage. FIG. 2 shows the case in which the voltage of the Y electrode is reduced in the ramp type. Then, the weak discharge is generated between the Y electrode and the X electrode and between the Y electrode and the A electrode while the voltage of the Y electrode is reduced and at the same time, the (−) wall charge formed in the Y electrode and the (+) wall charge formed in the X electrode and the A electrode are erased. Generally, the Ve voltage and the Vnf voltage are set to approach the wall voltage between the Y electrode and the X electrode to almost 0V, such that the cell not selected in the address period does not generate the sustain discharge in the sustain period. That is, the (Ve−Vnf) voltage is set to about discharge initial voltage between the Y electrode and the X electrode.

Thereafter, in order to select the light emitting cell and the non-emitting cell among the plurality of discharge cells in the corresponding subfield for the address period, the scan electrode driver 500 and the address electrode driver 300 applies the scan pulse having the VscL voltage and the address pulse having Va voltage to the Y electrode and the A electrode, respectively, in the state where the sustain electrode driver 400 maintains the voltage of the X electrode as the Ve voltage. The scan electrode driver 500 applies the VscH voltage higher than the VscL voltage to the Y electrode to which the scan pulse is not applied and applies the reference voltage to the A electrode to which the address pulse is not applied.

That is, the scan electrode driver 500 and the address electrode driver 300 applies the address pulse to the A electrode positioned at the light emitting cell in the first row while applying the scan pulse to the Y electrode (Y1 of FIG. 1) in the first row in an address period. Then, the address discharge is generated between the Y electrode (Y1 of FIG. 1) in the first row and the A electrode to which the address pulse is applied, so that the (+) wall charge is formed in the Y electrode (Y of FIG. 1) and the (−) wall charge is formed in the A and X electrodes, respectively. Thereafter, the scan electrode driver 500 and the address electrode driver 300 apply the address pulse to the A electrode positioned at the light emitting cell in the second row while applying the scan pulse to the Y electrode (Y2 of FIG. 1) in the second row. Then, the address discharge is generated in the cell formed by the A electrode to which the address pulse is applied and the Y electrode (Y2 of FIG. 1) of the second row, such that the wall charge is formed in the cell. Similarly, the scan electrode driver 500 and the address electrode driver 300 apply the address pulse to the A electrode positioned in the light emitting cell while sequentially applying the scan pulse to the Y electrode in the remaining row, thereby forming the wall charge.

In the sustain period, the scan electrode driver 500 applies the sustain pulse alternately having the high level voltage (Vs in FIG. 2) and the low level voltage (0V in FIG. 2) to the Y electrode as many as the frequency corresponding to the weight value of the corresponding subfields. The sustain electrode driver 400 applies the sustain pulse to the X electrode in an anti-phase to the sustain pulse applied to the Y electrode. As a result, the voltage difference between the Y electrode and the X electrode alternately has the Vs voltage and the −Vs voltage, such that the sustain discharge is repeatedly generated by a predetermined frequency in the light emitting cell.

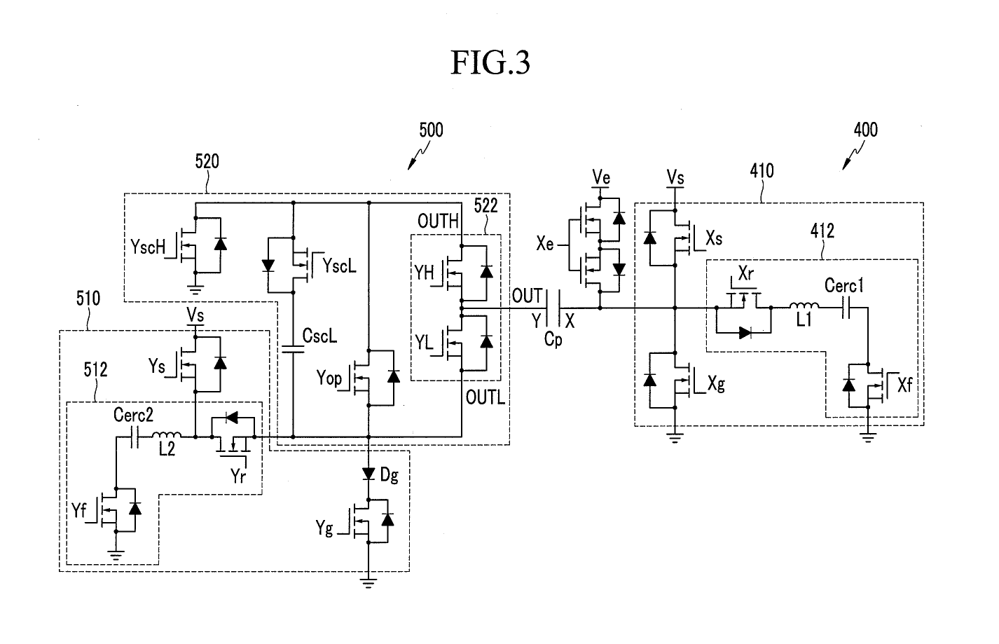

FIG. 3 is a diagram showing a driving circuit according to a first exemplary embodiment. For convenience, FIG. 3 shows only one X electrode and only one Y electrode and shows the capacitive component formed by the X electrode and the Y electrode as a capacitor (hereinafter, referred to as “panel capacitor”) Cp.

Referring to FIG. 3, the sustain electrode driver 400 includes transistors Xe1 and Xe2 and a sustain driver 410.

The sustain driver 410 includes transistors Xs and Xg and an energy recovery circuit 412. The energy recovery circuit 412 includes transistors Xr and Xf, an inductor L1, and a capacitor Cerc1.

In this case, each of the transistors Xe1, Xe2, Xs, Xg, Xr, and Xf is a switch having a control terminal, an input terminal, and an output terminal. FIG. 3 shows the case that the transistors Xe1, Xe2, Xs, Xg, Xr, and Xf are n-channel field effect transistors (FETs). In this case, the control terminal, the input terminal, and the output terminal correspond to a gate, a drain, and a source. These field effect transistors Xe1, Xe2, Xs, Xg, Xr, and Xf may each be formed with a body diode. In addition, instead of the n-channel FET, other transistors similar thereto may be used as these transistors Xe1, Xe2, Xs, Xg, Xr, and Xf. For example, an insulated gate bipolar transistor (IGBT) may be used as the transistors Xe1, Xe2, Xs, Xg, Xr, and Xf.

In detail, two transistors Xe1 and Xe2 are coupled between the X electrode and the power supply supplying the Ve voltage in series. In this case, the two transistors Xe1 and Xe2 are connected to each other in a back-to-back type that the sources thereof are connected to each other or the drains thereof are connected to each other. In addition, instead of the two transistors Xb1 and Xb2 connected in the back-to-back type, one transistor may be used. In the address period, the transistors Xe1 and Xe2 are turned on, the Ve voltage is applied to the X electrode.

In the sustain driver 410, the drain of the transistor Xs is connected to the power supply supplying the high level voltage Vs of the sustain pulse and the source thereof is connected to the X electrode. The transistor Xs is turned on when applying the high level voltage Vs of the sustain pulse to the X electrode in the sustain period. The drain of the transistor Xg is connected to the X electrode and the source thereof is connected to the power supply supplying the low level voltage 0V of the sustain pulse, for example, the ground terminal. The transistor Xg is turned on when the low level voltage 0V of the sustain pulse is supplied to the X electrode in the sustain period.

The source of the transistor Xr is connected to an X electrode and the drain of the transistor Xr is connected to one terminal of the inductor L1. The other terminal of the inductor L1 is one terminal of the capacitor Cerc1, the other terminal of the capacitor Cerc1 is connected to the drain of the transistor Xf and the source of the transistor Xf is connected to the ground terminal. The voltage charged in the capacitor Cerc1, which is voltage between the high level voltage Vs and the low level voltage 0V, for example, may be voltage Vs/2 corresponding to a half of the difference between the high level voltage Vs and the low level voltage.

Meanwhile, the source of the transistor Xr may be connected to the other terminal of the inductor and the drain of the transistor Xr may be connected to one terminal of the capacitor Cerc1.

The transistor Xr is turned on in the sustain period before the transistor Xs is turned on. The resonance between the inductor L1 and the panel capacitor Cp is generated by the turn-on of the transistor Xr to charge the panel capacitor Cp with the energy charged in the capacitor Cerc1, such that the voltage of the X electrode is increased to the vicinity of the Vs voltage from 0V. The transistor Xf is turned on in the sustain period before transistor Xg is turned on. The resonance between the inductor L1 and the panel capacitor Cp is generated by the turn-on of the transistor Xf to recover the energy discharged from the panel capacitor Cp to the capacitor Cerc1, such that the voltage of the X electrode is reduced to the vicinity of 0V from Vs voltage.

Next, the scan electrode driver 500 includes a sustain driver 510 and a reset scan driver 520.

The sustain driver 510 includes the transistors Ys, Yg, and Yop and the energy recovery circuit 512. The energy recovery circuit 512 includes transistors Yr and Yf, an inductor L2, and a capacitor Cerc2.

The reset scan driver 520 includes transistors YscH and YscL, a capacitor CscL, and a scan circuit 522. The scan circuit 522 includes a high voltage terminal OUTH, a low voltage terminal OUTL, an output terminal OUT. The scan circuit 522 may include two transistors YH and YL.

In this case, each of the transistors Ys, Yg, Yr, Yf, YscH, YscL, Yop, YH, and YL is a switch having a control terminal, an input terminal, and an output terminal. FIG. 3 shows the case that the transistors Ys, Yg, Yr, Yf, YscH, YscL, Yop, YH, and YL are re-channel field effect transistors (FETs). In this case, the control terminal, the input terminal, and the output terminal correspond to a gate, a drain, and a source, respectively. These field effect transistors Ys, Yg, Yr, Yf, YscH, YscL, Yop, YH, and YL may each be formed with a body diode (not shown). In addition, instead of the n-channel FET, other transistors similar thereto may be used as these transistors Ys, Yg, Yr, Yf, YscH, YscL, Yop, YH, and YL. For example, IGBT may be used as the transistors Ys, Yg, Yr, Yf, YscH, YscL, Yop, YH, and YL.

In detail, in the reset scan driver 520, the drain of the transistor YscL is connected to one terminal of the capacitor CscL, the source thereof is connected to the high voltage terminal OUTH, and the other terminal of the capacitor CscL is connected to the low voltage terminal OUTL. The capacitor CscL charges the (VscH−VscL) voltage.

The transistor YscL is turned on for the reset period and the address period to apply the gradually increasing voltage and gradually decreasing voltage to the Y electrode in the reset period and apply the VscL voltage to the Y electrode in the address period.

The gate of the transistor YscL may be connected to the two gate drivers (not shown). One of the two gate drivers applies the control signal to the gate of the transistor YscL for the reset period and the transistor YscL is driven by the control signal, thereby making it possible to gradually increase and reduce the voltage of the Y electrode. Specifically speaking, a ramp driver (not shown) may be connected between the gate of the transistor YscL of the reset scan driver 520 and the gate driver (not shown) so that the voltage of the Y electrode is gradually changed at the time of the turn-on of the transistor YscL. Therefore, when the transistor YscL is turned on, the voltage of the Y electrode may be changed into a ramp by the ramp driver (not shown). The ramp driver (not shown) may include resistance connected between the gate of the transistor YscL and the gate driver (not shown) and a capacitor connected between the gate of the transistor YscL and the transistor YscL.

The other one of two gate drivers connected to the gate of the transistor YscL applies the control signal to the gate of the transistor YscL for the address period and the transistor YscL is driven by the control signal to apply the VscL voltage to the Y electrode.

The drain of the transistor YscH is connected to the high voltage terminal OUTH and the source thereof is connected to the ground terminal, the drain of the transistor Yop is connected to the high voltage terminal OUTH and the source thereof is connected the low voltage terminal OUTL.

The drain of the transistor YH of the scan circuit 522 is connected to the high voltage terminal OUTH and the source thereof is connected to the output terminal OUT and the drain of the transistor YL is connected to the output terminal OUT and the source thereof is connected to the low voltage terminal OUTL.

One scan circuit 522 may correspond to one Y electrode and the reset scan driver 520 may be formed with a plurality of scan circuits corresponding to the plurality of Y electrodes (Y1 to Yn of FIG. 1), respectively. In this case, at least a part of the plurality of scan circuits is formed with one integrated circuit (IC) and the high voltage terminal OUTH and the low voltage terminal OUTL of the these scan circuits may each be formed in common.

In the address period, the transistor YscL is turned on, such that the low voltage terminal OUTL of the scan circuit 522 becomes to the VscL voltage. The transistor YL of the plurality of scan circuits 522 is sequentially turned on, such that the plurality of scan circuits 522 sequentially applies the voltage VscL of the low voltage terminal OUTL to a plurality of Y electrodes. Among the plurality of scan circuits 522, the scan circuit 522 in which the transistor YL is not turned on applies the voltage of the high voltage terminal OUTH, that is, the VscH voltage (0V in FIG. 3) to the Y electrode connected to the output terminal OUT by turning-on the transistor YH.

The sustain driver 510 is the same as the sustain driver 410 except that it is connected to the Y electrode.

In addition, when the transistor Yf is turned on, in order to lower the voltage of one terminal of the inductor L2 to the ground voltage or less, the sustain driver 510 may further include a diode Dg whose cathode is connected to the drain of the transistor Yg and an anode is connected to the low voltage terminal OUT.

In addition, in order to reduce the impedance of the current path in the sustain period, the sustain driver 510 may further include the transistor Yop whose drain is connected to the high voltage terminal OUTL of the scan circuit 522 and a source is connected to the low voltage terminal OUTL of the scan circuit 522.

For example, in the state where the transistor YL is turned on in the sustain period, when the transistor Yf is turned on, the current path through the transistor YL of the scan circuit 522, the body diode of the transistor Yr, the inductor L2, the capacitor Cerc2, the transistor Yf, and the ground terminal is formed. If the transistor Yop is turned on when the transistor Yf is turned on, the current path through the transistor YH of the scan circuit 522, the transistor Yop, the body diode of the transistor Yr, the inductor L2, the capacitor Cerc2, the transistor Yf, and the ground terminal is also formed. As such, if the transistor Yop is turned on in the sustain period, two current paths are formed in parallel when the transistor Yf is turned on, thereby making it possible to reduce the impedance on the current path.

In addition, the transistor YscH may also be turned on while being synchronized with the transistor Yg in the sustain period. In the case where the transistor YscH is turned on while being synchronized with the transistor Yg, when the transistors Yg and YscH are turned on, the current path through the transistor YL, the diode Dg, the transistor Yg, and the ground terminal and the current path through the body diode of the transistor YH, the transistor YscH, and the ground terminal may be simultaneously formed. Therefore, the ripple of the voltage may be reduced and the noise may be reduced, at the time of the sustain discharge.

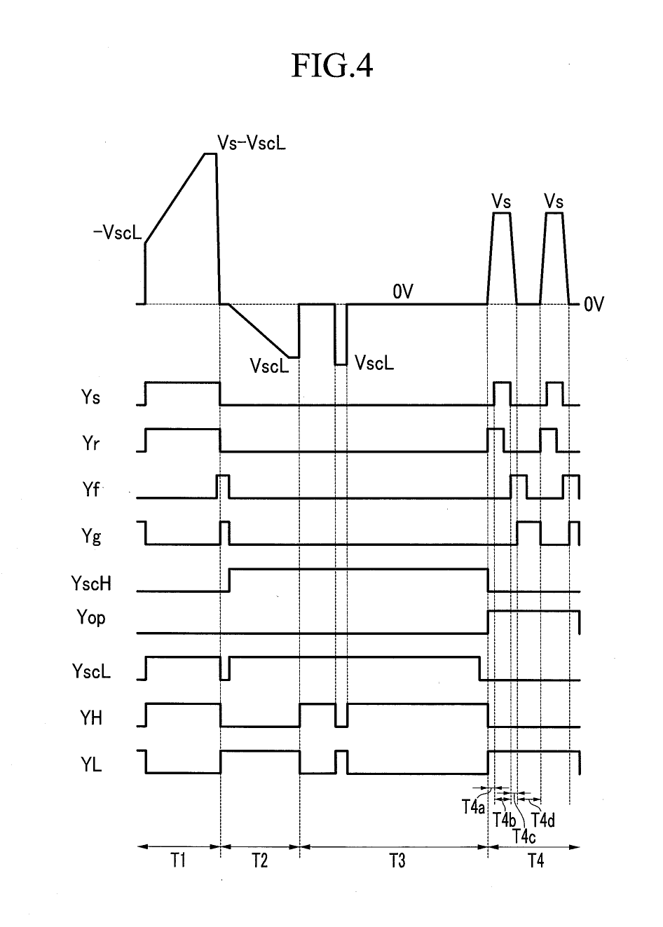

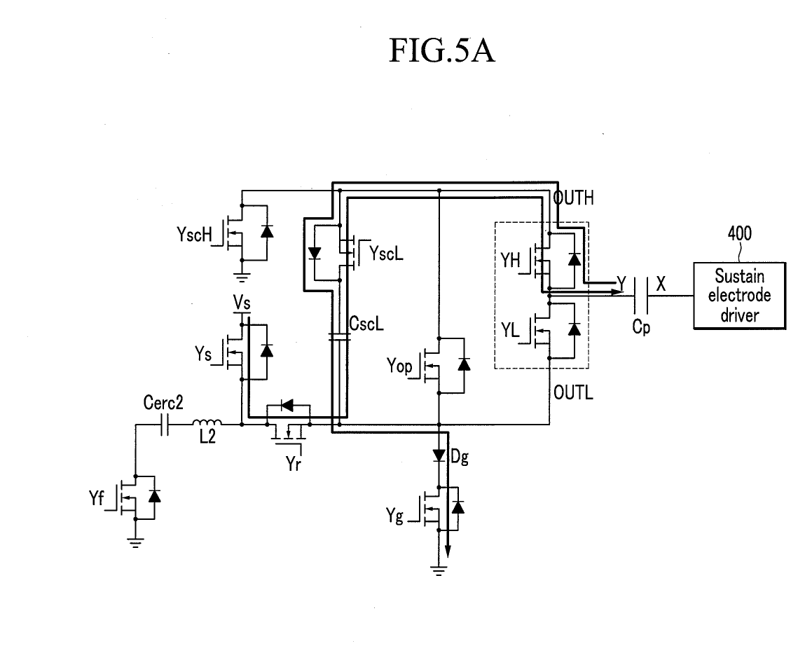

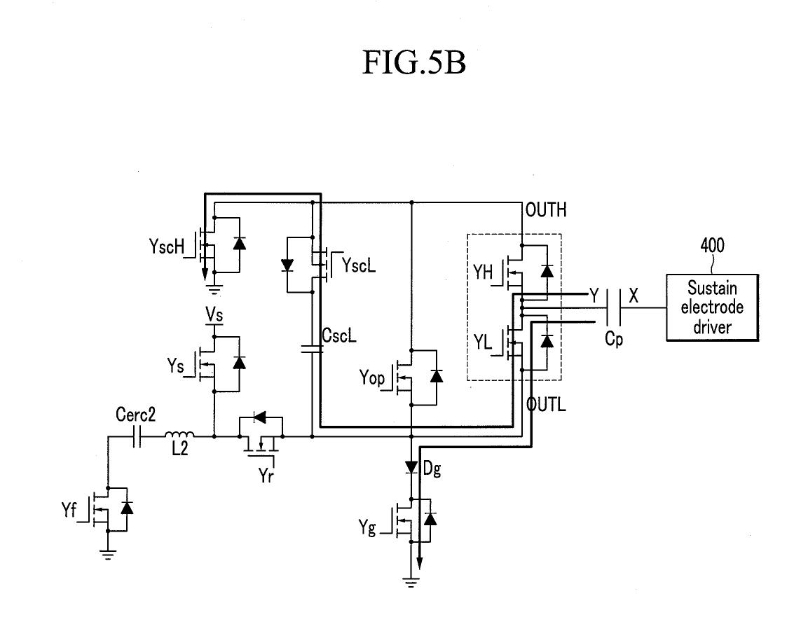

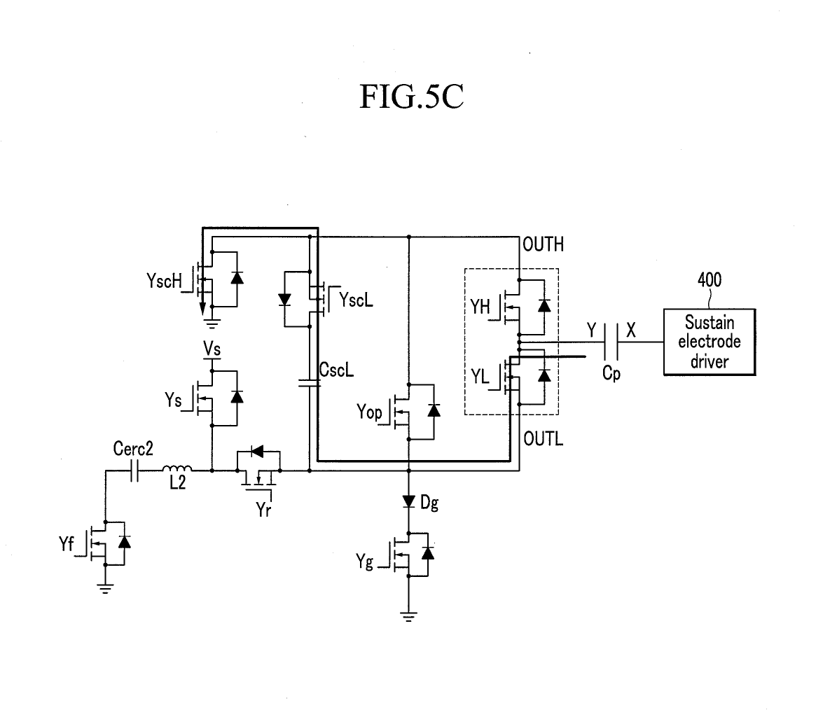

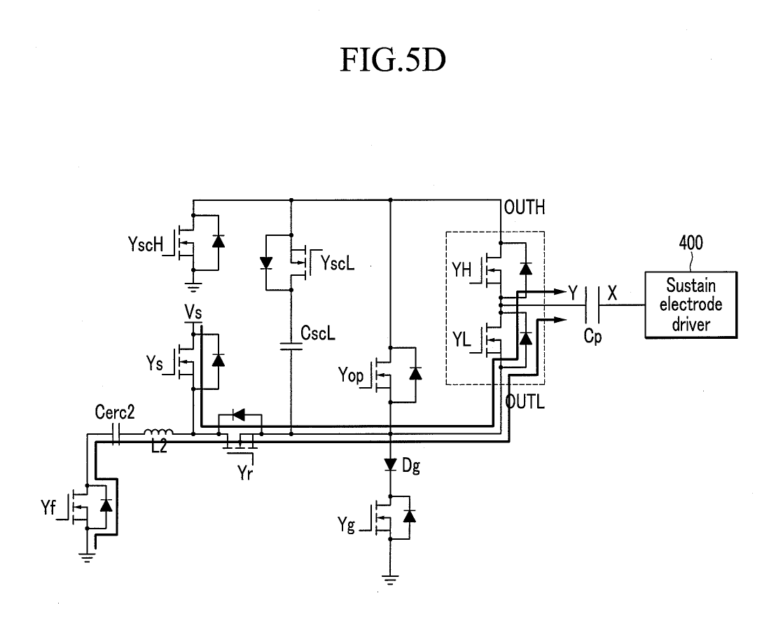

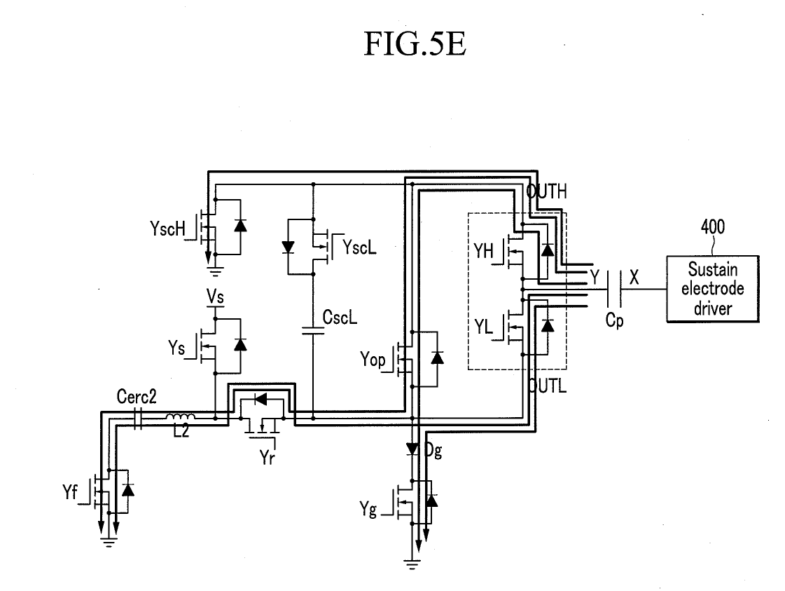

FIG. 4 is a signal timing drawing showing a driving circuit according to the first exemplary embodiment and FIG. 5A to FIG. 5E are drawings showing current paths according to the signal timing as shown in FIG. 4. For convenience, FIG. 4 shows only the signal timing for generating the driving waveform applied to the Y electrode.

FIG. 4 shows the voltage of the control signal applied to the gates of the transistors Xs, Xg, Xr, Xf, YscH, YscL, Yop, YH, and YL in order to the turn-on/turn-off state of the transistors Xs, Xg, Xr, Xf, YscH, YscL, Yop, YH, and YL. When the voltage of the control signal is a high level, the transistors Xs, Xg, Xr, Xf, YscH, YscL, Yop, YH, and YL are turned on and the voltage of the control signal is a low level, the transistors Xs, Xg, Xr, Xf, YscH, YscL, Yop, YH, and YL are turned off.

In addition, FIG. 4 describes the case where the VscH voltage of FIG. 3 becomes 0V, for the convenience of explanation.

Referring to FIGS. 4 and 5A, the transistors Yg and YL are turned on, the transistor YL is turned off in the rising period T1 of the reset period in the state where 0V voltage is applied to the Y electrode. Therefore, the voltage of the Y electrode becomes—VscL voltage through the high voltage terminal OUTH by the voltage charged in the capacitor CscH while the current path through the Y electrode, the body diode of the transistor YH, the body diode of the transistor YscL, the capacitor CscH, the diode Dg, the transistor Yg, and the ground terminal is formed.

Thereafter, the transistors Ys, Yr, YscL, are YH are turned on. Therefore, the voltage of the Y electrode is gradually increased from −VscL voltage to Vs−VscL voltage through the high voltage terminal OUTH by the voltage charged in the capacitor CscH while the current path through the power supply Vs, the transistor Ys, the transistor Yr, the capacitor CscL, the transistor YscL, the transistor YH, and the Y electrode is formed.

Referring to FIGS. 4 and 5B, the transistors YH, Yr, Ys, and YscL are turned off and the transistors YL and Yg are turned on in the falling period T2 of the reset period. Therefore, the voltage of the Y electrode becomes 0V through the low voltage terminal OUTL while the current path through the Y electrode, the transistor YL, the diode Dg, the transistor Yg, and the ground terminal is formed.

Thereafter, the transistor Yg is turned off and the transistors YscL and YscH are turned on. Therefore, the voltage of the Y electrode is gradually reduced from 0V to VscL voltage through the low voltage terminal OUTL by the voltage charged in the capacitor CscH while the current path through the Y electrode, the transistor YL, the capacitor CscL, the transistor YscL, the transistor YscH and the ground terminal is formed.

Meanwhile, when the voltage of the Y electrode immediately falls from the Vs−VscL voltage to 0V voltage, the self-erase discharge may occur. Therefore, the transistor Yf is turned on before the transistor Yg is turned on, thereby making it possible to slowly reduce the voltage of the Y electrode from the Vs−VscL voltage due to resonance of the inductor L2 and the panel capacitor Cp.

Referring to FIGS. 4 and 5C, in the state where transistors YscL and YscH are turned on, the transistor YL of the plurality of scan circuits 522 is sequentially turned on in the address period T3, such that the plurality of scan circuits 522 sequentially apply the voltage of the low voltage terminal OUTL to the plurality of Y electrodes. Among the plurality of scan circuits 522, the scan circuit 522 in which the transistor YL is not turned on applies the voltage of the high voltage terminal OUTH to the connected Y electrode by turning-on the transistor YH. In this case, the voltage of the low voltage terminal OUTL becomes the VscL voltage and the voltage of the high voltage OUTH becomes 0V.

Referring to FIGS. 4 and 5D, in the sustain period T4, transistors YscH and YscL are turned off and the transistor Yr is turned on for a period T4a. Therefore, in the current path through the ground terminal, the body diode of the transistor Yf, the capacitor Cerc2, the inductor L2, the transistor Yr, the body diode of the transistor YL, and the Y electrode, the resonance is generated between the inductor L2 and the panel capacitor Cp. In this case, the voltage of the Y electrode slowly rises through the low voltage terminal OUTL by the resonance.

When the voltage of the Y electrode rises to about Vs voltage, the transistor Ys is turned on, such that the period T4b starts. When the transistor YS is turned on, the voltage of the Y electrode is maintained at the Vs voltage while the current path of the power supply Vs, the transistor Ys, the body diode of the transistor YL, and the Y electrode is formed. The transistor Yf is turned off at the starting timing of the period T4b or during the progress of the period T4b.

Next, referring to FIGS. 4 and 5E, the transistor Ys is turned off and the transistor Yf is turned on in the period T4, such that the period T4c starts. Therefore, in the current path through the Y electrode, the transistor YL, the body diode of the transistor Yr, the inductor L2, the capacitor Cerc, the transistor Yf, and the ground terminal, the resonance is generated between the inductor L2 and the panel capacitor Cp. By this resonance, the voltage of the Y electrode slowly falls.

When the voltage of the Y electrode falls to about 0V, the transistor Xg is turned on, such that the period T4d starts. In this case, the voltage of the Y electrode is maintained at 0V through the current path through the Y electrode, the transistor YL, the diode Dg, the transistor Yg, and the ground terminal. The transistor Yf is turned off at the starting timing of the period T4d or during the progress of the period T4d.

In addition, the transistor YscH may be turned on while being synchronized with the transistor Xg in the sustain period. In this case, the current path through the Y electrode, the body diode of transistor YH, the transistor YscH, and the ground terminal may also be formed, together with the current path through the Y electrode, the transistor YL, the diode Dg, the transistor Yg and the ground terminal Y electrode.

In addition, the transistor Yop may by turned on for the sustain period. When the transistor Yop is turned on for the sustain period, in the current path through the Y electrode, the body diode of the transistor YH, the transistor Yop, the body diode of the transistor Yr, the inductor L2, the capacitor Cerc, the transistor Yf, and the ground terminal in the period T4c, the resonance is also generated between the inductor L2 and the panel capacitor Cp.

In addition, even in the period T4d, the current path through the Y electrode, the body diode of the transistor YH, the transistor Yop, the diode Dg, the transistor Yg, and the ground terminal may be formed.

As such, when the transistor. Yop is turned on for the sustain period, the two current paths are formed in parallel with each other when the transistors Yf and Yg are turned on and the impedance may be reduced by two current paths, thereby making it possible to reduce the circuit loss.

As such, reviewing the driving circuit according to the first exemplary embodiment, since there is no other transistors in the current path for applying the low level voltage, that is, 0V to the Y electrode in the sustain period, such that the voltage drop due to the transistor may be reduced, thereby making it possible to reduce the distortions of the sustain pulse.

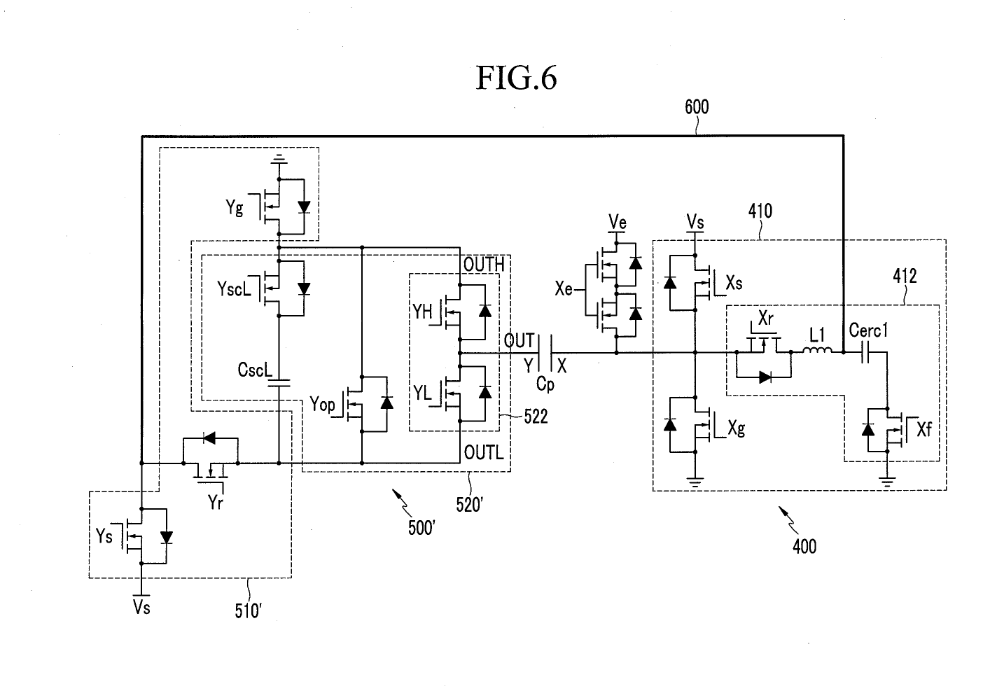

FIG. 6 is a drawing showing a driving circuit according to a second exemplary embodiment.

Referring to FIG. 6, the driving circuit according to the second exemplary embodiment includes a sustain electrode driver 400 and a scan electrode driver 500′ connected to the sustain electrode driver 400 and a harness 600.

The sustain electrode driver 400 is the same as the first exemplary embodiment.

The scan electrode driver 500′ includes reset scan driver 520′ and is the same as the scan electrode driver 500 according to the first exemplary embodiment except for the sustain driver 510′.

The harness 600 may include a plurality of wirings (hereinafter, referred to as “ground wiring”) used as a ground (GND) line and a plurality of wirings (hereinafter, referred to as ‘main path wiring’) used as a current line passing through current. In this case, the plurality of ground wirings are disposed at both sides, that is, the outside of the harness 600 and the plurality of main path wirings may be disposed between the ground wirings formed at both sides. The number of ground wirings may be the same as the number of main path wirings.

In more detail, unlike the sustain driver 510, the sustain driver 510′ of the scan electrode driver 500′ does not include the transistor Yf, the capacitor Cerc2, and the inductor L2 and the transistor Yg is connected to the high voltage terminal OUTH of the scan circuit 522.

In other words, in the scan electrode driver 500′ according to the second exemplary embodiment, the transistor Xf, the capacitor Cerc1, and the inductor L1 of the sustain electrode driver 400 are operated as the energy recovery circuit through the transistor Yr and the harness connecting the drain of the transistor Yr and the other terminal of the inductor L1.

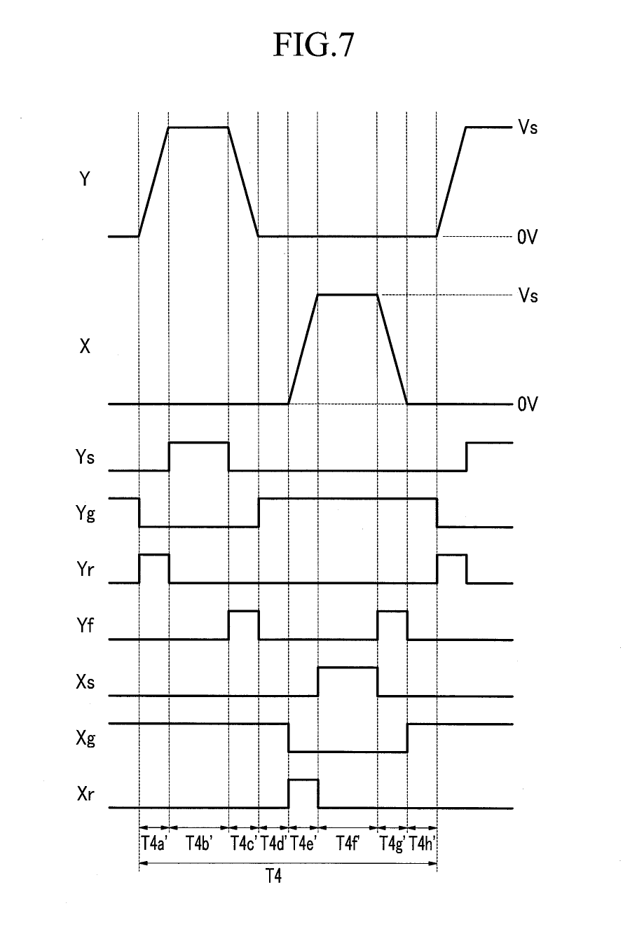

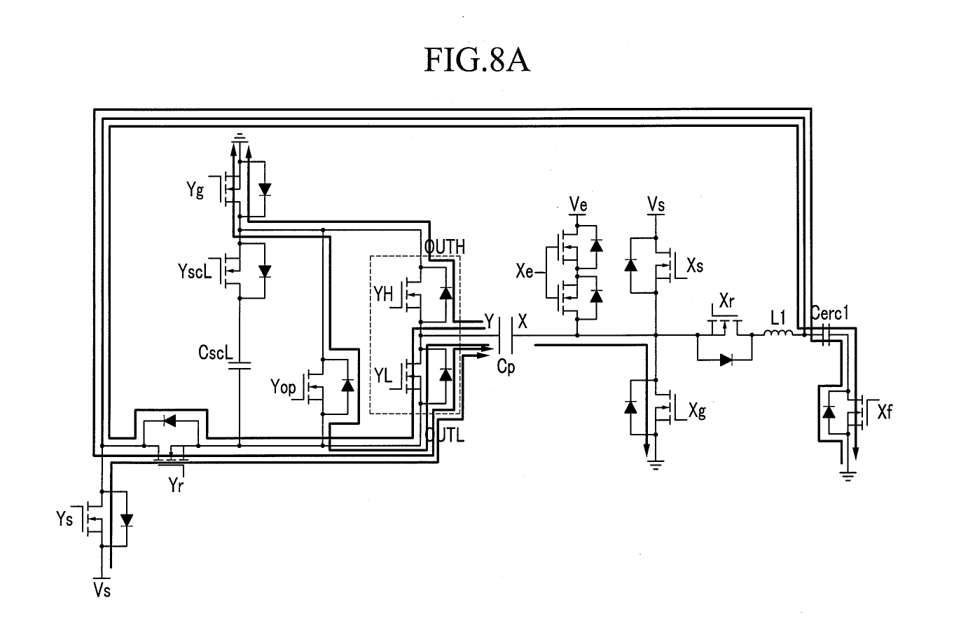

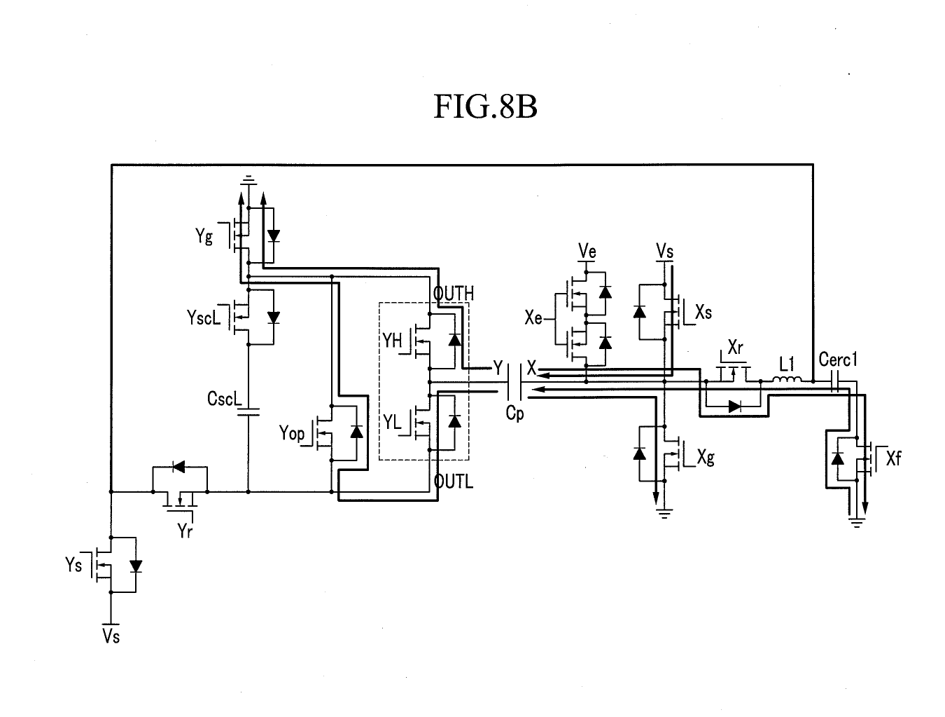

FIG. 7 is a signal timing drawing showing a driving circuit according to the second exemplary embodiment and FIG. 8A and FIG. 8B are drawings showing current paths according to a signal timing as shown in FIG. 7. In FIG. 7, in order to generate the sustain pulse in the sustain period, only the signal timings of the transistors Ys, Yg, Yr, Xs, Xg, Xr, and Xf are shown.

Referring to FIGS. 7 and 8A, in the state where the transistors Yg and Xg are turned on, the transistor Yr is turned on and the transistor Yg is turned off in the period T1a′ of the sustain period T4. Therefore, the current path through the ground terminal, the body diode of the transistor Xf, the capacitor Cerc1, the harness 600, the transistor Yr, the body diode of the transistor YL, and the Y electrode is formed. In this case, the voltage of the Y electrode slowly rises from 0V through the low voltage terminal OUTL while the resonance is generated by the inductance component of the harness 600 and the panel capacitor Cp.

When the voltage of the Y electrode rises to about Vs voltage, the transistor Ys is turned on, such that the period T4b′ starts. When the transistor Ys is turned on, the current path through the power supply Vs, the transistor Ys, the body diode of the transistor YL, and the Y electrode is formed, such that the voltage of the Y electrode is maintained at the Vs voltage.

Then, the transistor Ys is turned off and the transistor Xf is turned on in the period T4c ′. Therefore, the current path through the Y electrode, the transistor YL, the body diode of the transistor Yr, the harness 600, the capacitor Cerc1, the transistor Xf, and the ground terminal is formed. In this case, the voltage of the Y electrode slowly falls from the Vs voltage through the low voltage terminal OUTL while the resonance between the inductance component of the harness 600 and the panel capacitor Cp is generated.

When the voltage of the Y electrode is reduced to about 0V, the transistor Yg is turned on, such that the period T4d′ starts. When the transistor Yg is turned on, the voltage of the Y electrode is maintained at 0V while the current path through the Y electrode, the transistor YL, the body diode of the transistor Yop, the transistor Yg, and the ground terminal is formed. In this case, the current path through the Y electrode, the body diode of the transistor YH, the transistor Yg, and the ground terminal may be formed. As such, two current paths are formed in a period T4d′, thereby making it possible to reduce the circuit loss.

The transistor Xg is turned on for the period T4a′-T4d′, the voltage of the X electrode becomes 0V.

Next, referring to FIGS. 7 and 8B, the transistor Xg is turned off and the transistor Xr is turned on in the sustain period T4, such that the period T4e′ starts. Accordingly, a resonance occurs between the inductor L1 and the panel capacitor Cp in the current path through the ground terminal, the body diode of the transistor Xf, the capacitor Cerc1, the inductor L1, the transistor Xr and the X electrode. The voltage of the X electrode is gradually increased by the resonance.

When the voltage of the X electrode increases to about the Vs voltage, the transistor Xr is turned off and the transistor Xs is turned on, such that the period T4f′ starts. As the transistor Xs is turned on, the voltage of the X electrode is maintained at the Vs voltage while a current path through the power supply Vs, the transistor Xs, and the X electrode is formed.

Next, the transistor Xs is turned off and the transistor Xf is turned on, and the period T4g′ starts. Accordingly, resonance occurs between the inductor L1 and the panel capacitor Cp in the current path through the X electrode, the body diode of the transistor Xr, the inductor L1, the capacitor Cerc1, the transistor Yf and the ground terminal. The voltage of the X electrode is gradually reduced by the resonance.

When the voltage of the X electrode reduces close to 0V, the transistor Xs is turned off and the transistor Xg is turned on, such that the period T4h′ starts. Accordingly, while a current path through the X electrode, the transistor Xg and the ground terminal is formed, the voltage of the X electrode becomes 0V.

Further, the sustain electrode and the scan electrode drivers 400 and 500 can alternately apply sustain pulses having 0V voltage and Vs voltage to the Y electrode and the X electrode, by repeating the operation during the sustain periods (T4a′-T4h′) as many as the number of times corresponding to the weigh value of the corresponding subfield.

Since the driving circuit according to the second exemplary embodiment can apply a sustain pulse to the X electrode and the Y electrode, respectively, using one energy recovery circuit, the number of circuit devices used for the driving circuit can be reduced, thereby reducing the cost of the plasma display.

Further, the driving circuit according to the second exemplary embodiment, similar to the driving circuit according to the first exemplary embodiment, can reduce voltage drop due to the transistor, because another transistor does not exist in the current path for applying a low level voltage, that is, 0V to the Y electrode in the sustain period.

Further, the driving circuits according to the first and the second exemplary embodiments do not require a high-voltage-resistant, path blocking transistor and may use lower-voltage-resistant transistors as the transistors Yg, Yr, and Ys than when using the sustain discharge circuit (U.S. Pat. No. 4,866,349) proposed by L. F. Weber, as the sustain drivers 510 and 510′.

The above-mentioned exemplary aspects are not embodied only by an apparatus and/or method. Alternatively, the above-mentioned exemplary aspects may be embodied by a program for a computer performing functions, which correspond to the aspects or configurations of the exemplary embodiments, or a recording medium on which the program is recorded. These embodiments can be easily devised from the description of the above-mentioned exemplary embodiments by those skilled in the art to which the present invention pertains.

While various aspects have been described in connection with what is presently considered to be practical exemplary embodiments, it is to be understood that the invention is not limited to the disclosed embodiments, but, on the contrary, is intended to cover various modifications and equivalent arrangements.

What is claimed is:

1. A plasma display, comprising:
a scan electrode;
a scanning circuit including a high voltage terminal and a low voltage terminal, and configured to drive the scan electrode with a scan signal having a voltage of the high voltage terminal or a voltage of the low voltage terminal;
a first sustain driver configured to apply a first sustain signal alternately having a first voltage and a second voltage to the scan electrode during a sustain period, wherein the second voltage is greater than the first voltage;
a first capacitor connected between the low voltage terminal and the high voltage terminal, and configured to store a third voltage; and
a first transistor connected between the first capacitor and the high voltage terminal and turned on during an address period,
wherein the scanning circuit comprises:
a second transistor comprising a first terminal connected to the high voltage terminal and a second terminal connected to a first power supply configured to supply the first voltage, and
a third transistor connected between the low voltage terminal and a second power supply configured to supply the second voltage.

2. The plasma display of claim 1, wherein the first and third transistors are turned on during a reset period to gradually increase the voltage of the scan electrode to a fourth voltage through the high voltage terminal, wherein the fourth voltage is substantially equal to the sum of the second voltage and the third voltage.

3. The plasma display of claim 1, wherein the first and second transistors are turned on during a reset period to gradually reduce the voltage of the scan electrode to a fourth voltage through the low voltage terminal, and wherein the fourth voltage is substantially equal to the voltage obtained by subtracting the third voltage from the first voltage.

4. The plasma display of claim 1, further comprising:
a fourth transistor connected between the high voltage terminal and the first power supply,
wherein the first and fourth transistors are turned on during a reset period to gradually reduce the voltage of the scan electrode to the fourth voltage through the low voltage terminal, wherein the fourth voltage is substantially equal to the voltage obtained by subtracting the third voltage from the first voltage.

5. The plasma display of claim 4, wherein the first sustain driver is synchronized with second transistor to turn on the fourth transistor during the sustain period.

6. The plasma display of claim 1, further comprising:
a fourth transistor connected between the high voltage terminal and the low voltage terminal, and is turned on during the sustain period.

7. The plasma display of claim 1, further comprising:
a sustain electrode extending in the same direction with the scan electrode, and
a second sustain driver configured to apply a second sustain pulse alternately having the first voltage and the second voltage to the scan electrode in anti-phase to the first sustain pulse for a sustain period.

8. The plasma display of claim 7, wherein
the first sustain driver further includes a first energy recovering circuit reducing the voltage of the scan electrode by using a first inductor connected between the scan electrode and a second capacitor applying a voltage between the first voltage and the second voltage before the first voltage is applied, and increasing the voltage of the scan electrode with the first inductor before the second voltage is applied, and
the second sustain driver includes a second energy recovery circuit reducing the voltage of the scan electrode with a second inductor connected between the scan electrode and a third capacitor applying a voltage between the first voltage and the second voltage before the first voltage is applied, and increasing the voltage of the scan electrode with the second inductor before the second voltage is applied.

9. The plasma display of claim 7, further comprising a harness connecting the first sustain driver and the second sustain driver.

10. The plasma display of claim 9, wherein:
the second sustain driver includes:
a second capacitor that applies the voltage between the first voltage and the second voltage, the second capacitor having a first terminal connected to the first power supply and a second terminal connected to the sustain electrode,
an inductor connected between the second terminal of the second capacitor and the sustain electrode,
a fourth transistor connected between the sustain electrode and the inductor, and
a fifth transistor connected between the capacitor and the first power supply, and
the first sustain driver further includes a sixth transistor having a first terminal connected to the low voltage terminal and a second terminal connected to the first terminal of the second capacitor through the harness.

11. The plasma display of claim 10, wherein:
the fifth and the sixth transistors each include a body diode,
the first sustain driver turns on the sixth transistor before the third transistor is turned on to increase the voltage of the scan electrode through a path formed by the harness, and
the first sustain driver turns on the fifth transistor before the third transistor is turned on to increase the voltage of the scan electrode through a path formed by the harness.

12. A driving apparatus of a plasma display, the display including a scan electrode and a sustain electrode for performing a display operation, the display comprising:
a scanning circuit including a high voltage terminal and a low voltage terminal, and configured to drive the scan electrode with a scan signal having a voltage of the high voltage terminal or a voltage of the low voltage terminal;
a first capacitor connected between the low voltage terminal and the high voltage terminal; and configured to store a third voltage;
a first transistor comprising a first terminal connected to the high voltage terminal and a second terminal connected to a first power supply configured to supply the first voltage;
a second transistor connected between the low voltage terminal and a second power supply configured to supply the second voltage; and
a third transistor connected between the first capacitor and the high voltage terminal and is turned on during a sustain period,
wherein the first and the second transistors are alternatively turned on during the sustain period.

13. The apparatus of claim 12, further comprising:
a fourth transistor connected between the first capacitor and the high voltage terminal, and is turned on during an address period.

14. The apparatus of claim 13, wherein:
the second and fourth transistors are turned on during a reset period, and a voltage of the scan electrode is increased to voltage that is substantially equal to a sum of the second voltage and the third voltage, and
the first and fourth transistors are turned on during the reset period to reduce the voltage of the scan electrode to voltage substantially equal to the voltage obtained by subtracting the third voltage from the first voltage.

15. The apparatus of claim 12, further comprising:
a fourth transistor connected to the first capacitor and the high voltage terminal, and is turned on during the address period, and
a fifth transistor connected between the high voltage terminal and the first power supply.

16. The apparatus of claim 15, wherein:
the second and fourth transistors are turned on during the reset period, and a voltage of the scan electrode is increased to voltage that is substantially equal to a sum of the second voltage and the third voltage, and
the first and fifth transistors are turned on during the reset period to reduce the voltage of the scan electrode to a voltage substantially equal to the voltage obtained by subtracting the third voltage from the first voltage.

17. The apparatus of claim 12, further comprising:
a fourth transistor having a first terminal connected to the sustain electrode and a second terminal connected to the first power supply, and
a fifth transistor having a first terminal connected to the sustain electrode and a second terminal connected to the second power supply,
wherein the fifth transistor is on while the first transistor is on, and the fourth transistor is on while the second transistor is on.

18. The apparatus of claim 17, further comprising:
a second capacitor that stores a voltage between the first voltage and the second voltage, and has a first terminal connected to the sustain electrode and a second terminal connected to the first power supply,
wherein the first terminal of the second capacitor is connected to the scan electrode and a harness.

19. The apparatus of claim 18, further comprising:
a sixth transistor connected between the second terminal of the second capacitor and the first power supply, and
a seventh transistor connected to the first terminal of the second capacitor through the low voltage terminal and the harness,
wherein the sixth and the seventh transistors include a body diode, the seventh transistor is turned on before the second transistor is turned on to increase the voltage of the scan electrode, and the sixth transistor is turned on before the first transistor is turned on, to reduce the voltage of the scan electrode.

20. The apparatus of claim 19, further comprising:
an inductor connected between the second capacitor and the sustain electrode, and
an eighth transistor connected between the sustain electrode and the inductor or the inductor and the second capacitor.
